(19) United States
(12) Patent Application Publication
(10) Pub. No.: US 2006/0019543 A1
(43) Pub. Date: Jan. 26, 2006

(54) USB powered electronic device

(76) Inventor: Sharon Lin Charna, Newport Coast, CA (US)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(21) Appl. No.: 11/114,697

(22) Filed: Apr. 26, 2005

Related U.S. Application Data
(60) Provisional application No. 60/591,180, filed on Jul. 26, 2004.

(51) Int. Cl. H01R 25/00

(52) U.S. Cl. 439/638

(57) ABSTRACT

Disclosed is an electronic device that draws electric power from a notebook or desktop computer through USB port. The electronic device includes a USB interface, a power cable or a female connector, wherein the power cable can be physically adjusted in any angle.

### BACKGROUND OF THE INVENTION

1. Field of the Invention

The present invention relates to an electronic device, and in particular to a USB powered electronic device that can be powered by a USB port of a computer.

2. The Related Art

The universal serial bus (USB) is currently one of the most popular communication interfaces between peripheral devices and a computer. The USB port supports fast I/O operation, hot swapping, and device identification as compared with the conventional serial port. Since the USB port allows the computer operating systems to recognize plug-in devices automatically, currently available electronic products, such as handheld game players, MP3, digital cameras, printers and scanners, all provided USB access ports as a standard feature.

### SUMMARY OF THE INVENTION

The primary objective of the present invention is to provide an electronic device that draws on electric power from a host computer through USB port connection, without using additional wall outlet.

The electronic device is electrically connected with the host computer through the USB port. Further, the electronic device may take the forms of many different electronic gadgets, even when the electronic gadgets do not have built-in USB ports.

The electronic device includes a USB interface to gain power from the computer. The USB interface is made available either on a power cable wired to the device, or it is in the form of a female connector on the device.

When USB interface of the electronic device is connected to the USB port of the host computer, the host computer powers the device.

In accordance with the present invention, the host computer can be a desktop computer, a notebook computer, a handheld computer, a PDA, or a powered USB hub.

In accordance with the present invention, examples of the external electronic device include decoration lamps shaped like a Christmas Tree, Teddy Bear, Snowman, fish tank, transparent snow ball, or other adorable figurines.

In accordance with the present invention, the electronic device can also be installed with a sound circuit to playback pre-recorded greeting messages or other sound effects in addition to the existing light effects.

In accordance with the present invention, the electronic device can be installed with a DC motor that is used to drive moving parts such as legs, hands, arms, and body of the figurine.

In accordance with the present invention, the electronic device is compatible with other electronic devices and gadgets, such as mini fans, electronic clocks, electronic watches, notebook coolers, and mug warmers.

The present invention will become more obvious from the following description and drawings, which show, for purposes of illustration only, a preferred embodiment in accordance with the present invention.

### BRIEF DESCRIPTION OF THE DRAWINGS

FIG. 1 is a perspective view of an electronic device constructed in accordance with the present invention;

FIG. 2 is a diagram showing internal structure of a USB interface of the electronic device that is used to adapt a USB lamp in accordance with the preferred embodiment of the invention;

FIG. 3 is a schematic diagram of a figurine shaped lamp that is electrically connected on the notebook computer in accordance with the preferred embodiment of the invention; and

FIGS. 4A-4E are popular figurine shapes on the decoration lamps.

### DETAILED DESCRIPTION OF THE PREFERRED EMBODIMENTS

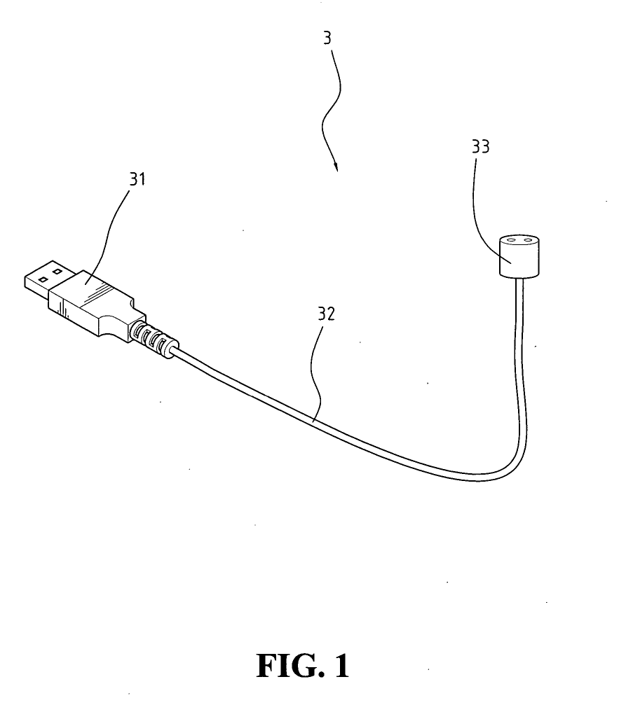

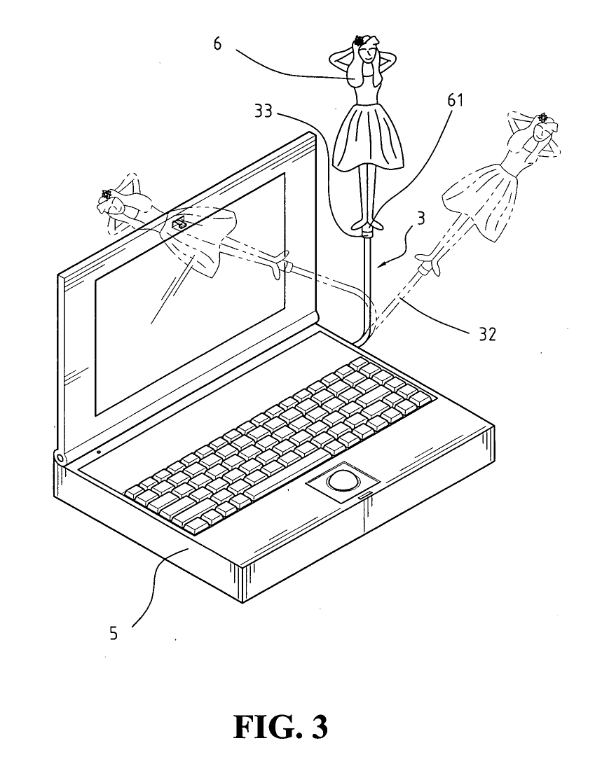

With reference to the drawings and in particular to FIG. 1, an electronic device constructed in accordance with the present invention, generally designated with reference numeral 3, draws electric power from a host computer 5, such as a notebook computer (see FIG. 3), a desktop computer, a personal digital assistant (PDA), and a handheld computer, through a USB port of the computer 5. The connection is made by coupling the electronic device 3 to the host computer 5.

The electronic device 3 comprises a USB interface 31, which in the embodiment illustrated is made in the form of a power cable 32 having a female connector 33, which is preferably in conformance with standard USB specification, such as USB1.1 and USB2.0. The USB interface 31 is engageable with the USB port of the computer 5 to obtain power from the computer 5. The female connector 33 is mateable with a counterpart male connector formed in an external device that consumes power from the computer 5 for the operation of the external device.

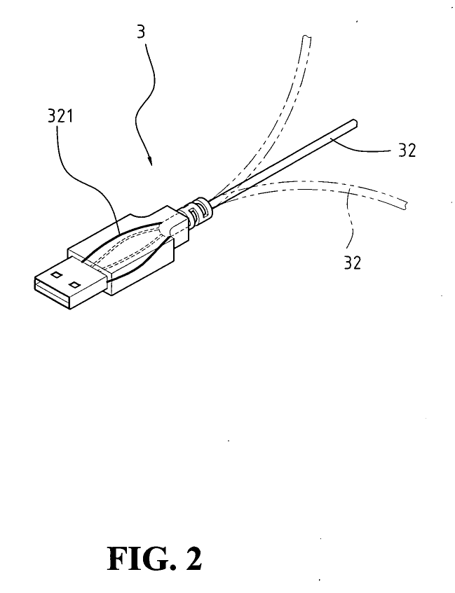

Referring to FIG. 2, the power cable 32 of the electronic device has two core wires 321 connected to power lines in the USB interface 31, in order to deliver electric power from the host computer 5 to the external device. The cable 32 is flexible, which allows the cable 32 to be adjustable in orientation, position, and configuration.

The shape and specifications of the female power connector 33 is in full compliance with the standard specifications for electrical appliances, so that the male connector of the external device can be smoothly fitted into the female power connector 33 to establish an electrical connection between the electronic device 3 and the external device.

Referring to FIG. 3, the external device comprises a figurine shaped lamp or illuminating device, which is broadly designated with reference numeral 6. The female connector 33 of the electronic device 3 is connected with the male connector 61 of the figurine shaped lamp 6, and the USB interface 31 engages the USB port or socket of the computer 5. The figurine lamp 6 draws electric power through the USB socket of the notebook computer 5 to light up the lamp 6. The flexible power cable 32 allows for physical adjustment in angle of the lamp 6.

The electronic device 3 can be available in several form factors. In the present example, the lamp 6 is installed with an audio sound circuit with pre-recorded greetings and messages, such as “congratulations”, “good luck”, “good morning to you”, “have a nice day”, “thinking of you”, or other refreshing messages. When the lamp 6 is activated, the messages are played back. Also, the lamp 6 can include a DC motor, so that when the lamp 6 is activated, the hands, arms, legs, or body of the figurine will be programmed to move with possible light and sound effects.

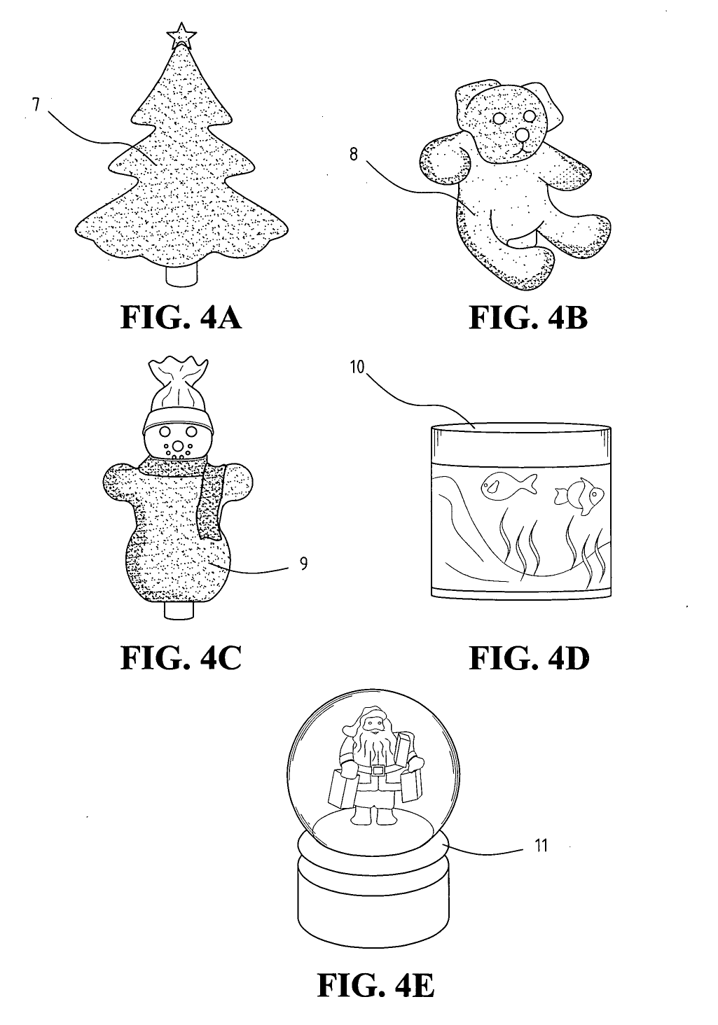

The lamp 6 can be constructed with many different shapes, such as Christmas Tree 7, Teddy Bear 8, Snowman 9, fish tank 10, transparent snowball 11, as shown in FIGS. 4A-4E, or other adorable decorations.

Furthermore, the electronic device in accordance with the present invention can be different electronic gadgets and devices such as mini fan, electronic clock, electronic watch, notebook cooler, mug warmer and others alike. This provides convenience to the users.

Although the present invention has been described with reference to the preferred embodiments thereof, variation and modifications of the concept may be made without departing from the scope of the present invention.

What is claimed is:

1. A USB powered electronic device, comprising:
a USB interface adapted to receive power supply from a host computer;
a cable connected between the USB interface and a connector that is connectable with a counterpart connector of a power consuming device; wherein when the electronic device is connected to the USB port of the host computer, and after the power of the host computer is turned on, electric power is continuously supplied from the host computer to the power consuming device through the USB port connection.

2. The electronic device as claimed in claim 1, wherein the USB interface is in conformance with standard USB 1.1 and 2.0 specifications.

3. The electronic device as claimed in claim 1, wherein the host computer is a desktop computer, notebook computer, handheld computer, or PDA.

4. The electronic device as claimed in claim 1, wherein the power consuming device is in the shape of Christmas Tree, Teddy Bear, Snowman, fish tank, or transparent snow ball.

5. The electronic device as claimed in claim 1, wherein the power consuming device comprises an audio sound circuit.

6. The electronic device as claimed in claim 1, wherein the power consuming device comprises a motor.

7. The electronic device as claimed in claim 1, wherein the electronic device is compatible with currently available electronic gadgets such as mini fans, electronic clocks, electronic watches, notebook coolers, and mug warmers.
